(19) United States
(12) Patent Application Publication
(10) Pub. No.: US 2023/0087308 A1
(43) Pub. Date: Mar. 23, 2023

(54) TIMING MEASUREMENT (TM)/FINE TIMING MEASUREMENT (FTM) FOR RANGING AND TIMING

(71) Applicant: Cisco Technology, Inc., San Jose, CA (US)

(72) Inventors: Malcolm Muir Smith, Richardson, TX (US); Jerome Henry, Pittsboro, NC (US); Maik Guenter Seewald, Nürnberg (DE); Sanjay Katabathuni, Freemont, CA (US)

(73) Assignee: Cisco Technology, Inc., San Jose, CA (US)

(21) Appl. No.: 17/481,784

(22) Filed: Sep. 22, 2021

(51) Int. Cl. H04W 56/00; H04W 48/16

(52) U.S. Cl. CPC H04W 56/001; H04W 48/16; H04W 56/007

(57) ABSTRACT

Ranging and timing may be provided. A station may send an action frame. The action frame may include an Identifier (ID) associated with an upcoming Timing Measurement (TM)/Fine Timing Measurement (FTM) session. The action frame may indicate a purpose of the upcoming TM/FTM session. Next, the station may send, subsequent to sending the action frame, a TM/FTM session request associated with the action frame. The station may then perform the purpose indicated by the action frame.

### TECHNICAL FIELD

The present disclosure relates generally to Timing Measurement (TM)/Fine Timing Measurement (FTM) for ranging and timing.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing ranging and timing;

FIG. 2 is a flow chart of a method for providing ranging and timing; and

FIG. 3 is a block diagram of a computing device.

### DETAILED DESCRIPTION

### Overview

Ranging and timing may be provided. A station may send an action frame. The action frame may include an Identifier (ID) associated with an upcoming Timing Measurement (TM)/Fine Timing Measurement (FTM) session. The action frame may indicate a purpose of the upcoming TM/FTM session. Next, the station may send, subsequent to sending the action frame, a TM/FTM session request associated with the action frame. The station may then perform the purpose indicated by the action frame.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Institute of Electrical and Electronics Engineers (IEEE) 802.1AS standard defines a mechanism to support Generic Precision Time Protocol (gPTP) (e.g., Time-Sensitive Networking (TSN) based time synchronization) over Wi-Fi via the Timing Measurement (TM) or Fine Timing Measurement (FTM) protocol by integration of the two processes at the protocol level (i.e., IEEE 802.11 Vendor Specific Information Elements (VSIEs) contained in IEEE 802.11 action frames transmitted within FTM request/response messages). As the use cases increase beyond a single-robot-client-in-a-factory-syncing-its-internal-clock case, the current standard finds its limit. With TM/FTM for ranging (i.e., location) purposes, a station may initiate a ranging exchange, and the upper layers may consume the range finding to position the station in the space domain. With TM/FTM for time synchronization purposes, the station may initiate the same ranging exchange, but with the goal of consuming the Time-of-Flight (ToF) and additional information returned by an Access Point (AP) to synchronize the station’s clock.

Implementation of the standard reveals that the usage of TM/FTM for either IEEE 802.1AS time synchronization or ranging (i.e., location services) was ambiguous because the standard solution calls for the same approach for both (i.e., IEEE 802.11 VSIEs contained in 802.11 action frames transmitted within FTM request/response messages). For example, with a collection of Virtual Reality (VR) headsets in an interactive group game, each station may need to detect its position in space (e.g., FTM to detected APs or TM to local AP) and also synchronize its clock with a game server. A station may occasionally initiate a TM/FTM session, but the AP may have no way to know if the goal is ranging (i.e., location services) or time in-advance of receiving the TM/FTM request, and thus the AP may not know if the station expects follow up Information (i.e., time synchronization) in the answer. Additionally, the AP may signal its support for TM/FTM (extended capabilities), but the station may have no knowledge that the AP supports the technologies for ranging purposes only, or if the AP may also provide time synchronization support. This lack of knowledge breaks the process, not only because either side may send messages that the other side may not not understand, but also because the wrong guess from either side breaks the exchange because the ranging parameters (e.g., ASAP mode, burst count/duration etc.) required for TM/FTM are different depending on whether the goal is ranging or time synchronization.

Because the above approach is problematic, embodiments of the disclosure may allow the standard to support ranging for both purposes and enable both sides to have a clear understanding of the goals and modes of the exchanges. Embodiments of the disclosure may provide a process to allow TM/FTM to be used in a hybrid (relationship life) environment, where stations may require TM/FTM exchanges for ranging (i.e., location services) purposes, for time synchronization purposes, or both. With embodiments of the disclosure, contextual information exchanged between the stations may be allowed thus the aforementioned ambiguity between ranging and time synchronization may be resolved.

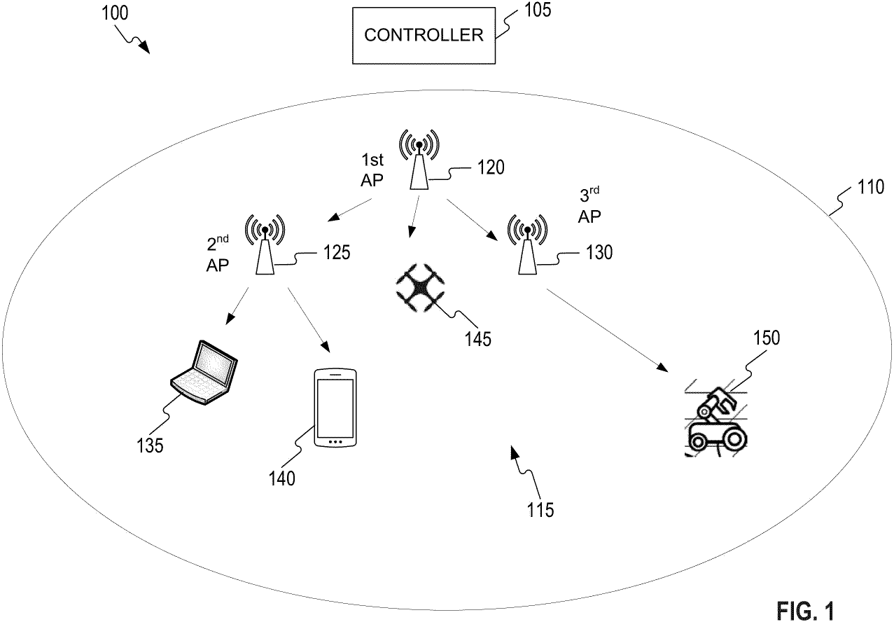

FIG. 1 shows an operating environment 100 for providing ranging and timing. As shown in FIG. 1, operating environment 100 may comprise a controller 105 and a coverage environment 110. Coverage environment 110 may comprise, but is not limited to, a Wireless Local Area Network (WLAN) comprising a plurality of stations 115. The plurality of stations 115 may comprise a plurality of Access Points (APs) and a plurality of client devices. At any given time, any one of the plurality of stations 115 may comprise an Initiating Station (ISTA) or a Responding Station (RSTA). The plurality of APs may provide wireless network access (e.g., access to the WLAN) for the plurality of client devices. The plurality of APs may comprise a first AP 120, a second AP 125, and a third AP 130. Each of the plurality of APs may be compatible with specification standards such as, but not limited to, the Institute of Electrical and Electronics Engineers (IEEE) 802.11 specification standard for example. Coverage environment 110 may comprise, but is not limited to, an outdoor wireless environment, such as a mesh (e.g., a Wi-Fi mesh). Embodiments of the disclosure may also apply to indoor wireless environments and non-mesh environments.

Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, an Unmanned Aerial Vehicle (UAV), or other similar microcomputer-based device. In the example shown in FIG. 1, the plurality of client devices may comprise a first client device 135 (e.g., a laptop computer), a second client device 140 (e.g., a smart phone), a third client device 145 (e.g., a drone), and a fourth client device 150 (e.g., an ATV).

Controller 105 may comprise a Wireless Local Area Network controller (WLC) and may provision and control operating environment 100 (e.g., the WLAN). Controller 105 may allow the plurality of client devices to join operating environment 100. In some embodiments of the disclosure, controller 105 may be implemented by a Digital Network Architecture Center (DNAC) controller (i.e., a Software-Defined Network (SDN) controller) that may configure information for operating environment 100 in order to provide ranging and timing consistent with embodiments of the disclosure.

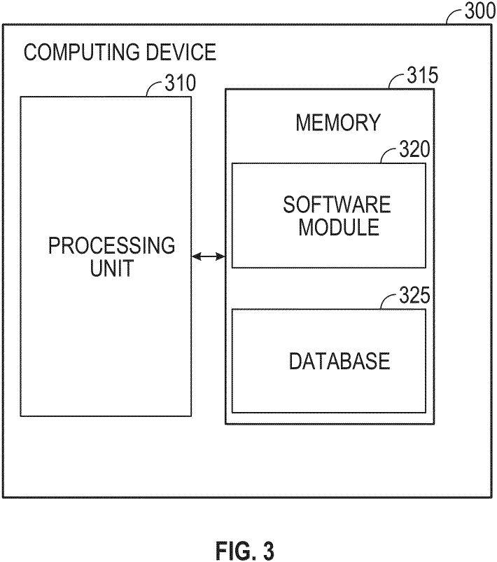

The elements described above of operating environment 100 (e.g., controller 105, first AP 120, second AP 125, third AP 130, first client device 135, second client device 140, third client device 145, and fourth client device 150) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

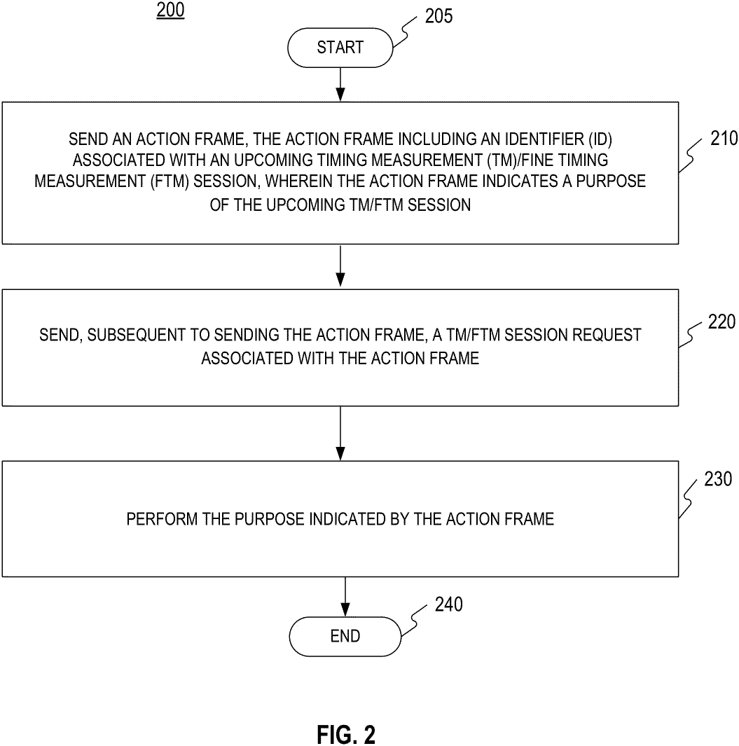

FIG. 2 is a flow chart setting forth the general stages involved in a method 200 consistent with an embodiment of the disclosure for providing ranging and timing. While method 200 may be implemented using any of the plurality of stations as described in more detail above with respect to FIG. 1, method 200 is described below using first AP 120 as an example. Ways to implement the stages of method 200 will be described in greater detail below.

Method 200 may begin at starting block 205 and proceed to stage 210 where first AP 120 may send an action frame. The action frame may include an Identifier (ID) associated with an upcoming Timing Measurement (TM)/Fine Timing Measurement (FTM) session. The action frame may indicate a purpose of the upcoming TM/FTM session. For example, as stated above, the conventional IEEE 802.1AS over FTM/TM scheme may be problematic because it may require a station to guess that an AP (or other station) supports time synchronization, and the AP assumes that the station cannot ask for TM/FTM exchange for any other reason than time synchronization. Accordingly, embodiments of the disclosure may insert the exchange in a larger framework, where contextual information may be added to allow each side to choose the appropriate mode or purpose of the exchange.

With embodiments of the disclosure, both sides of the TM/FTM exchange may signal the TM/FTM usage information (e.g., FTM is asCapable and the next FTM session is for time synchronization) outside of the FTM/TM transaction itself. As described below, on embodiment may include a context free action frame and another embodiment may include a contextual action frame.

For example, in one embodiment, a context free action frame (e.g., from an ISTA or an RSTA) may be sent that precedes the TM/FTM request and may contain the upcoming TM/FTM session ID (i.e., parameters in the MLME-FINETIMINGMSMT.request such as Peer Media Access Control (MAC) Address and Dialog Token) and whether it is for ranging (i.e., location) or IEEE 802.1AS time synchronization. In addition, the action frame may include parameters specific to the upcoming TM/FTM session. For time synchronization, parameters such as key gPTP parameters (e.g., domain) may also provided in the action frame thus informing the receiving station (e.g., AP) gPTP daemon that time-services will be requested via TM or FTM and it should take appropriate action such as Grandmaster (GM)/Master Clock (MC) time-stamping and connect to the TM/FTM process loading appropriate FTM parameters (e.g., burst rate as per 802.1AS-2020). A variation of this embodiment may include a response to the action frame indicating the time at which this service is available (e.g., if GM time-sync is underway). Other variations may provide TM/FTM parameters specific to the IEEE 802.1AS time synchronization function (e.g., versus the location function).

In another embodiment, a contextual action frame may be sent (from an ISTA or an RSTA) that follows an AP advertisement/beacon, and that contains IEEE 802.1AS asCapable bits (e.g., FTM can be used for gPTP for a default or specific gPTP domain). Like the above embodiment, the action frame may precede the TM/FTM request and may contain the upcoming FTM session ID (i.e., forthcoming parameters in the MLME-TIMINGMSMT.request such as Peer MAC Address and Dialog Token) and whether it is for ranging (i.e., location) or IEEE 802.1AS time synchronization. However, unlike the above embodiment, the receiving station (e.g., AP) may already be primed to deliver IEEE 802.1AS over TM/FTM, so no service delay may be seen. The action frame may simply indicate which TM/FTM session serves which purpose (i.e., ranging (i.e., location), time synchronization, or both).

From stage 210, where first AP 120 sends the action frame, method 200 may advance to stage 220 where first AP 120 may send, subsequent to sending the action frame, a TM/FTM session request associated with the action frame. For example, embodiments of the disclosure may provide a process to allow TM/FTM to be used in a hybrid environment, where stations may require TM/FTM exchanges for ranging purposes, time synchronization purposes, or both. With embodiments of the disclosure, a contextual information exchange between the stations via the action frame may allow the ambiguity as to the purpose of the TM/FTM exchange to be resolved. Thus, the TM/FTM session request may be sent subsequent to the resolution of this ambiguity.

Once first AP 120 sends, subsequent to sending the action frame, the TM/FTM session request associated with the action frame in stage 220, method 200 may continue to stage 230 where first AP 120 may perform the purpose indicated by the action frame. For example, first AP 120 may carry out the TM/FTM session indicate by the action frame, for example, ranging (i.e., location), time synchronization, or both. Once first AP 120 performs the purpose indicated by the action frame in stage 230, method 200 may then end at stage 240.

In yet another embodiment, an application running on a station, which may be the entity in need of ranging, time synchronization, or both, may be exchanging with a server. Events in the exchange may trigger the need for time synchronization or ranging update. The server may then signal the current need, and therefore the next exchange purpose, to controller 105, an AP, or a station providing the ranging or time synchronization. For example, the server may push a time update (e.g., because the server is itself a time-master, or because it expects time synchronization after each master time update push) to the AP. Upon receiving the time updates, the AP may set the next exchange with the stations as IEEE 802.1AS-type. Similarly, the server may ask the WLC (e.g., controller 105) or AP for a ranging update about a station (e.g., Location Measurement Report (LMR) feedback), thus signaling to the AP that the next exchange is for ranging purposes. Other signaling frames may be sent to the AP from infrastructure devices (e.g., an application server or a network management entity) that may signal to the AP the purpose of the next exchange.

Consistent with embodiments of the disclosure, a station (or client app) may indicate the usage of TM/FTM for ranging, time synchronization, or both in which case either the station or the AP may provide blended ranging parameters (e.g., burst duration long enough for both processes, shortest period, etc.).

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing ranging and timing as described above with respect to FIG. 2. Computing device 300, for example, may provide an operating environment for controller 105, first AP 120, second AP 125, third AP 130, first client device 135, second client device 140, third client device 145, and fourth client device 150. Controller 105, first AP 120, second AP 125, third AP 130, first client device 135, second client device 140, third client device 145, and fourth client device 150 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
sending, by a station, an action frame, the action frame including an Identifier (ID) associated with an upcoming Timing Measurement (TM)/Fine Timing Measurement (FTM) session, wherein the action frame indicates a purpose of the upcoming TM/FTM session;
sending, subsequent to sending the action frame, a TM/FTM session request associated with the action frame; and
performing, by the station, the purpose indicated by the action frame.

2. The method of claim 1, wherein the purpose of the upcoming TM/FTM session comprises ranging.

3. The method of claim 2, wherein the action frame includes parameters specific to the upcoming TM/FTM session comprises ranging.

4. The method of claim 1, wherein the purpose of the upcoming TM/FTM session comprises time synchronization.

5. The method of claim 4, wherein the action frame includes parameters specific to the upcoming TM/FTM session comprises time synchronization.

6. The method of claim 1, further comprising sending, prior to sending the action frame, an advertisement beacon indicating that the station is capable of using the TM/FTM session for time synchronization.

7. The method of claim 1, wherein the station comprises one of an Initiating Station (ISTA) and a Responding Station (RSTA).

8. The method of claim 1, wherein the purpose of the upcoming TM/FTM session comprises both ranging and time synchronization.

9. A system comprising:
a memory storage; and
a processing unit, the processing unit disposed in a station and coupled to the memory storage, wherein the processing unit is operative to:
send an action frame, the action frame including an Identifier (ID) associated with an upcoming Timing Measurement (TM)/Fine Timing Measurement (FTM) session, wherein the action frame indicates a purpose of the upcoming TM/FTM session;
send subsequent to sending the action frame, a TM/FTM session request associated with the action frame; and
perform the purpose indicated by the action frame.

10. The system of claim 9, wherein the purpose of the upcoming TM/FTM session comprises ranging.

11. The system of claim 10, wherein the action frame includes parameters specific to the pcoming TM/FTM session comprises ranging.

12. The system of claim 9, wherein the purpose of the upcoming TM/FTM session comprises time synchronization.

13. The system of claim 12, wherein the action frame includes parameters specific to the upcoming TM/FTM session comprises time synchronization.

14. The system of claim 9, wherein the processing unit is further operative to send, prior to sending the action frame, an advertisement beacon indicating that the station is capable of using the TM/FTM session for time synchronization.

15. A computer-readable medium that stores a set of instructions which when executed perform a method executed by the set of instructions comprising:
sending, by a station, an action frame, the action frame including an Identifier (ID) associated with an upcoming Timing Measurement (TM)/Fine Timing Measurement (FTM) session, wherein the action frame indicates a purpose of the upcoming TM/FTM session;
sending, subsequent to sending the action frame, a TM/FTM session request associated with the action frame; and
performing, by the station, the purpose indicated by the action frame.

16. The computer-readable medium of claim 15, wherein the purpose of the upcoming TM/FTM session comprises ranging.

17. The computer-readable medium of claim 16, wherein the action frame includes parameters specific to the upcoming TM/FTM session comprises ranging.

18. The computer-readable medium of claim 15, wherein the purpose of the upcoming TM/FTM session comprises time synchronization.

19. The computer-readable medium of claim 18, wherein the action frame includes parameters specific to the upcoming TM/FTM session comprises time synchronization.

20. The computer-readable medium of claim 15, further comprising sending, prior to sending the action frame, an advertisement beacon indicating that the station is capable of using the TM/FTM session for time synchronization.
